(19) United States
(12) Patent Application Publication
(10) Pub. No.: US 2015/0347160 A1
(43) Pub. Date: Dec. 3, 2015

(54) METHOD OF ANALYZING CONFIGURATION DATA

(71) Applicant: MATTHEW WILLIAMS, (US)

(72) Inventor: MATTHEW WILLIAMS, Auckland (NZ)

(21) Appl. No.: 14/649,662

(22) PCT Filed: Dec. 5, 2013
(86) PCT No.: PCT/NZ2013/000223

§ 371 Date: Jun. 4, 2015

(30) Foreign Application Priority Data
Dec. 5, 2012 (NZ) 601565

(51) Int. Cl. G06F 9/445; G06F 3/0484

(52) U.S. Cl. CPC G06F 9/44505; G06F 3/0484

(57) ABSTRACT

The invention relates to a computer-implemented method, system and apparatus of analysing configuration data comprising one or more configuration settings. In one embodiment of the invention, the method comprises identifying one or more configuration settings in configuration data, determining a setting type of each configuration setting, receiving a selection of the settings or setting types for validation, and validating one or more of the identified configuration settings based on the setting type of the identified configuration settings. A number of different algorithms for automatically determining setting types in configuration data are disclosed, as well as algorithms to validate the detected settings.

### CLAIM FOR PRIORITY

This application claims priority to and is a 371 national stage application of PCT/NZ2013/000223, having an international filing date of Dec. 5, 2013, the contents of which are hereby incorporated by reference.

### TECHNICAL FIELD OF DISCLOSURE

The disclosure relates to a computer-implemented method of analyzing configuration data. In particular, the disclosure relates to a method of validating configuration settings.

### BACKGROUND TO THE DISCLOSURE

In computing, configuration data configure the initial settings for a computer program or application. Configuration data is commonly stored, amongst other places, in configuration files. Configuration files may be read by a computer program when starting up or periodically while they are running to check for changes. Configuration files are critical to a program or application running correctly.

Software applications are commonly developed in non-critical environments such as a development environment. Once completed, they may be tested in a test environment. An application may need to be configured in a certain way to enable it to run correctly in these environments. The configurations may need to be changed if the application is to run correctly once deployed to the production or live environment.

Sometimes software is deployed to a production environment in a misconfigured state, for example as a result of changes from the configurations necessary for the software to work in another environment not being made. Since configuration files can be large and complex in nature, which increases the possibility of errors being made. Misconfigured software may not run or function incorrectly.

For example, configuration errors may cause XML files not to be delivered to their intended destinations, perhaps because a folder at the intended destination has been deleted or access permissions changed. In another example, strings in a configuration file may cause an error if they point to a file or location on a computer that, because of a change in environment, is no longer accessible to the configuration file in its new location.

The errors caused by mis-configured software can have wide-ranging ramifications. Perhaps most relevant to many businesses is that such errors can be extremely costly to deal with, and services can be interrupted while the problem is fixed. Mis-configured software can cause physical damage or loss of life, for example if the software is responsible for controlling machinery or air traffic control systems. It is therefore desirable for configuration files to contain as few errors as possible.

Manually checking configuration files is a time consuming task that is prone to human error and not practical in many situations. As a result, some automatic configuration file checkers have been developed. Examples are Microsoft Web Application Configuration Analyzer and the disclosure disclosed in US 2011/0239055, which concerns a system framework for identifying root causes of configuration errors and best practice in compliance of distributed applications. These examples are rule-centric systems that load validation rules from a rule store and access the configuration data based on metadata associated with each validation rule. They address errors in configuration files not conforming to best practices. As such, they address errors that, while not ideal, will not prevent a program or application from running. These examples do not address critical errors which prevent the program working at all.

Another problem with the aforementioned existing configuration file checkers is that they are not focussed on addressing errors in configuration data that is unique to a specific application, for example user-defined configuration settings. Non user-defined configuration settings are often constrained to certain pre-defined values and may be validated by existing software checking functionality such as that provided by the .NET framework. However, non-constrained settings and user-defined settings are more difficult to check.

### ANALYZING SUMMARY OF THE DISCLOSURE

The disclosure provides a method of analyzing configuration data. Alternatively, there is a method, computer program product or system that addresses one or more of the problems identified above. Alternatively, the disclosure at least provides the public with a useful choice.

According to a first embodiment of the disclosure, there is provided a computer-implemented method of analyzing configuration data comprising one or more configuration settings, the method comprising:
identifying one or more configuration settings in the configuration data;
determining a setting type of each configuration setting; and
validating one or more of the identified configuration settings based on the setting type of the identified configuration settings.

In one aspect, the method comprises:
presenting to an interface the identified configuration settings; and
receiving a selection of one or more of the identified configuration settings; and
validating the selected identified configuration settings.

The method may further comprise:
presenting to the interface the setting types of the identified configuration settings;
receiving a selection of one or more of the setting types for validating; and
validating the identified configuration settings that match the selection of setting types.

The method may further comprise associating one or more validations with the identified configuration settings.

The method may further comprise:
presenting to the interface the validations associated with the identified configuration settings;
receiving a selection of one or more of the validations; and
validating the identified configuration settings according to the selected validations.

The method comprises presenting the results of the step of validating the identified configuration settings to the interface. Additionally, the method comprises presenting the results of the step of validating on the interface with the configuration data.

In other embodiments of the disclosure, the method comprises presenting information relating to the results on the interface. For example, the information may comprise a statement or explanation as to why the validation passed or failed, and/or, in the case of a failed validation, a suggestion of what may help to pass the validation. Additionally, the method comprises generating the information relating to the results based on the step of validating.

In some exemplary embodiments of the disclosure, the interface is a user interface. Alternatively, the interface may be an Application Programming Interface (API).

The step of determining the setting type of each configuration setting may comprise implementing one or more algorithms wherein each algorithm determines whether the respective configuration setting is of a particular configuration setting type.

Additionally, the method comprises ceasing the step of determining once a positive identification of a configuration setting type has been made.

The method comprises determining whether each identified configuration setting is one of one or more of the following configuration setting types: a blank configuration setting; a configuration setting comprising a Boolean value or a long integer value; an email address; a directory/LDAP query; a website or web service URL; an IP address or hostname; a database connection string; or a file or folder.

The step of validating the identified configuration settings may comprise validating one or more of the following: a database connection; ability to write to a file/folder; existence of a file or folder; validity of a directory domain; validity of a local host; connectivity to an IP address or hostname; and existence of a web page or website.

In one aspect, the method comprises performing a preliminary check on the configuration data to ensure it is suitable for analysis.

In one aspect, the configuration settings are user-defined.

In one aspect, one or more timeout settings for connection to a remote location may be configured through an interface. Additionally, the method comprises presenting timeout settings to a user on a user interface, receiving a new timeout setting(s) selected by the user and executing timeouts based on the new timeout setting(s).

According to a second embodiment of the disclosure, there is provided a computer program product which, when executed on a computer, causes the computer to perform a method according to the first aspect of the disclosure.

According to a third embodiment of the disclosure, there is provided a computer-readable medium having stored thereon computer-executable instructions which, when executed on a computer, causes the computer to perform a method according to the first aspect of the disclosure.

According to a fourth embodiment of the disclosure, there is provided a system of analyzing configuration data comprising one or more configuration settings, the system comprising:
an identifier identifying one or more configuration settings in the configuration data;
for a determiner determining a setting type of each configuration setting; and
for a validator validating one or more of the identified configuration settings based on the setting type of the identified configuration settings.

Further aspects of the disclosure, which should be considered in all its novel aspects, will become apparent to those skilled in the art upon reading of the following description which provides at least one example of a practical application of the disclosure.

### BRIEF DESCRIPTION OF THE DRAWINGS

One or more embodiments of the disclosure will be described below by way of example only, and without intending to be limiting, with reference to the following drawings, in which:

FIG. 1 is a flow chart diagram of an exemplary method of analyzing configuration data according to an embodiment of the disclosure;

FIG. 2 is a screenshot of an exemplary GUI according to an embodiment of the disclosure allowing a user to select a configuration file for analysis;

FIG. 3 is a screenshot of an exemplary GUI according to an embodiment of the disclosure illustrating a configuration file being parsed;

FIG. 4 is a screenshot of an exemplary GUI according to an embodiment of the disclosure illustrating the results of the setting type determination;

FIG. 5 is a screenshot of an exemplary GUI illustrating the validation process in progress according to one embodiment of the disclosure;

FIG. 6 is a screenshot of an exemplary GUI presenting the results of validation of configuration data according to one embodiment of the disclosure;

FIG. 7 is a screenshot of an exemplary GUI presenting more detailed results of validation of configuration data according to the embodiment of the disclosure shown in FIG. 6; and

FIG. 8 is a screenshot of an exemplary GUI more detailed results of validation of configuration data according to the embodiment of the disclosure shown in FIG. 6.

### DETAILED DESCRIPTION OF THE DISCLOSURE

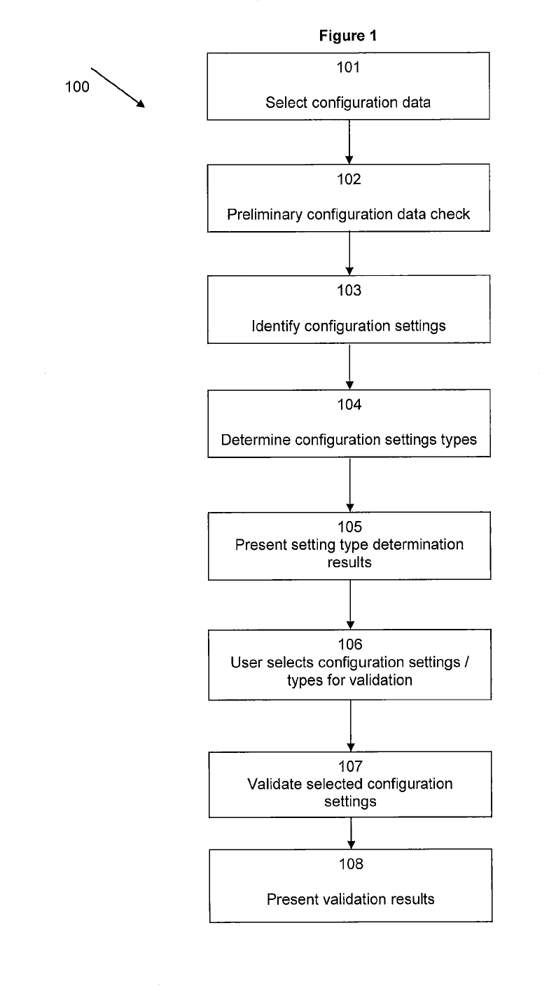

An exemplary method 100 of analyzing configuration data according to an embodiment of the disclosure is illustrated in the flow chart diagram of FIG. 1. The method 100 will be described in terms of analyzing configuration data that is stored in a configuration or config file. The exemplary method will also be described with reference to a number of screenshots. The screenshots illustrate example graphical user interfaces (GUIs) which may be presented to a user to enable the user to control the configuration data analysis and to view the results of that analysis. It will be understood that the exemplary GUIs shown in the screenshots are not limiting to the disclosure and any GUIs, if any, may be provided to allow a user to interact with a tool or software that performs a method according to the disclosure.

Preliminary Steps

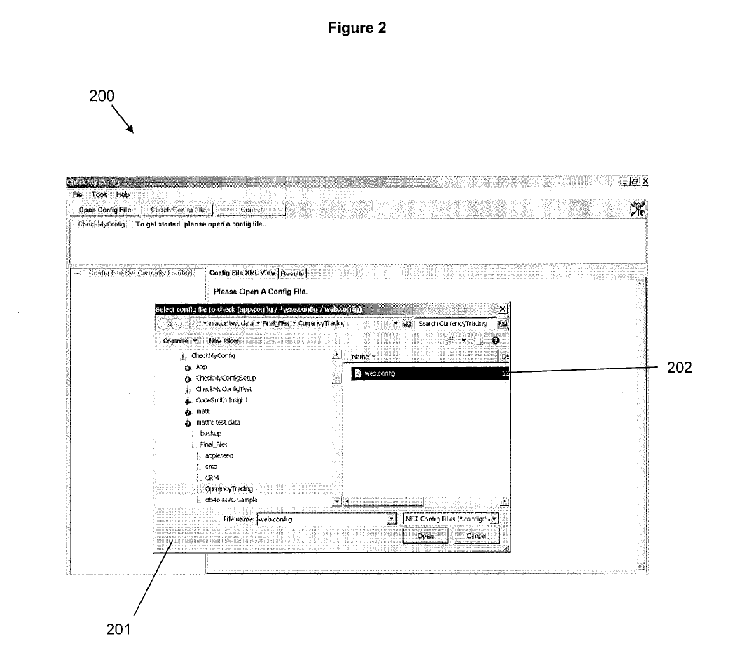

At step 101, configuration data is selected for analysis. For example, this step may involve a user selecting a configuration file in which the configuration data is stored. The configuration file may be stored in any location, for example locally on the computing device the user is working on. FIG. 2 is a screenshot of an exemplary GUI 200 allowing a user to select a configuration file for analysis. In GUI 200, a window 201 has opened allowing the user to browse stored files and select a file 202 for analysis.

Once the configuration data has been selected, step 102 comprises performing preliminary checks on the configuration data to ensure it is suitable for analysis. For example, if the configuration data is stored in a configuration file, step 102 may comprise checking that:
the configuration file exists;
the configuration file is able to be accessed;
the configuration file has a .config extension (for example, myapplication.exe.config);
the XML in the configuration file is well-formed, for example all the elements have closing tags, there are no overlapping tags, etc;
the XML contained within the file validates against any published XML standards, for example the Microsoft XML schema for configuration files; and
there are no other problems with the configuration file that would prevent it being parsed. For example, if there are more than one AppSettings or ConnectionStrings sections in the configuration file.

If any of these preliminary checks fail then the method may not be able to proceed. The user is presented with a message identifying why the preliminary check was failed and has the ability to correct the errors. With some of the checks, for example checking against a published XML schema, the method may still be able to proceed but the user may be presented with a warning to allow correction if required.

Parsing the Configuration Data

Next, the configuration data is parsed to identify what configuration settings it contains. The parsing process comprises, at step 103, identifying one or more configuration settings contained in the data. A configuration setting in configuration data may, in the example of configuration data stored in a configuration file, be defined as any of the following:
An individual entry within the “ConnectionStrings” section of the configuration file;
An individual entry within the “ApplicationSettingsGroup” section of the configuration file;
An individual entry within the “UserSettingsGroup” section of the configuration file;
An individual XML element anywhere within the configuration file that has attributes of “key” AND “value” OR just “key′, e.g. <add key=“MyConnectionString” value=“Data Source=c:\MyData.sdf;Max Database Size=256;Persist Security Info=False;”/>;
An individual element in the configuration file named “network”, e.g. <network host=“localhost” port=“25” password=“fred” userName=“you@yoursite.com”;
An individual element in the configuration file named “sessionState”, e.g. <sessionState mode=“SQLServer” sqIConnectionString=“data source=127.0.0.1;user id=<username>;password=<strongpassword>”.

As part of the identification, the total number of settings in the configuration file may be counted or calculated. This allows feedback on the progress of the parsing process to be provided to the user, for example by means of a progress bar. For example, if a configuration file contains ten different settings, as each setting is parsed, the progress bar would increment by 10% each time.

The next step in the parsing process, at step 104, is to determine the type of each configuration setting identified in step 103. There are many types of configuration settings. In the description below we explain exemplary methods for determining the following types of configuration setting:
Web site or web service (e.g. http://www.trademe.co.nz);
IP address or host (e.g. 192.168.0.1);
File or folder (e.g. C:\myfolder); and
Database connection string.

An explanation of exemplary methods for determining these types of settings is provided by means of example only. The disclosure is not limited to the identification or determination of any particular types of configuration settings and those of skill in the art will appreciate that other types of configuration settings could also be determined. For example, other setting types may include:
Email address;
Directory/LDAP query (e.g. an Active Directory query for querying Active Directory, a dedicated database for network management in a Microsoft Windows network and contains information on users, security and email distribution groups, printers, computers and so on);
Blank configuration setting (i.e. the setting has a key but the associated value is blank);
Unknown setting type (the type of setting cannot be determined using the determination method described herein); or
Configuration setting with exception (e.g. where an internal error occurred during parsing).

In some embodiments of the disclosure, configuration settings conforming to one or more of the types listed immediately above may not be analysed. This may be desirable to increase the efficiency of the disclosure, for example because it may be impractical to validate the setting in an automated fashion. For example, it may be difficult to verify that that an email address exists other than by sending an email and waiting for a reply, which may be impractical for an automated analysis tool. However, configuration settings conforming to these types may still be displayed to the user, so that they can be manually reviewed for correctness.

We will now describe exemplary methods of determining the aforementioned types of configuration settings.

1. Database Connection Strings

An exemplary method may begin by iterating through the settings contained within the ConnectionStrings section of the configuration file. This section (which may not always be present for any given configuration file) is specifically designed to hold connection strings. Typically, each setting corresponds to one connection string. Parsing this section may have less complexity than other parts of the parsing process since other types of settings such as files/folders and IP addresses are not usually present in this section. However, database connection strings may also be present outside of the ConnectionStrings section. Therefore, embodiments of the disclosure also comprise the application of the method described below to parts of the configuration file not in the ConnectionStrings section.

For each configuration setting identified in the ConnectionStrings section it is determined whether the name of a data provider is specified alongside the connection string. In this context, a data provider is a piece of software provided by the database manufacturer—for example, Oracle provide software which allows software developers to establish a connection programmatically to an Oracle database. Each provider has its own rules about what a connection string is allowed to contain—manufacturers have a lot of proprietary options which are only applicable to a given type of database. See www.connectionstrings.com for examples.

If the data provider name has been specified, the corresponding software provided by the manufacturer can be loaded (e.g. the Oracle data provider). The loaded data provider is then used as a means of validating (via a class called the ConnectionStringBuilder) that the connection string is correct in terms of syntax for the specified provider. This validation may not guarantee that the connection will work when it is opened, only that the connection string conforms to the rules regarding the connection string format. Assuming that this validation is successful, the relevant setting is considered as identified and stored for presenting to the user for possible selection for validating later in the process.

If the provider name has not been specified, the setting may still be able to be identified by making assumptions about what it could be. In order to do this, the method may iterate through all providers installed on the computer the analysis is being run on. On a typical computer, this might include Microsoft SQL server, Oracle, MySQL, etc. For each installed data provider, the provider-specific ConnectionStringBuilder is used to assess the validity of the connection string for a particular provider. It might be that there are several possible providers which are valid. As long as at least one provider is able to validate the connection string, the setting has been identified as a database connection string.

It is noted that the Microsoft ODBC and OLEDB connection string builders are relatively loose in their validation. Some things which are not connection strings may actually pass validation according to the method described above. For example, the following string (which is actually a regular expression, not a connection string) may be incorrectly interpreted as a connection string:
‘“(?=̂.{8,15}$)(?=.*\d)(?=.*[a-z])(?=.*[A-Z])(?=.[!@#$%̂&*( )_+])(?!.*\s).*$”

Therefore, in some embodiments, it may be necessary to perform some additional validation, in order to filter out such ‘bogus’ connection strings. For example, for an ODBC connection string at least one of the following values has to be present in the string:
DSN; or
Driver.

In another example, for an OLEDB connection string at least one of the following values has to be present in the string:
File Name;
Provider; or
Data Source.

In some rare cases, there might be an entry in the ConnectionStrings section which cannot be validated by any of the providers. In this case, in some embodiments, it may still be marked as a configuration setting for possible future validation since it is possible that it is in a legal format that is unable to be identified by the method explained above. Also, it is possible that the entry may be able to be validated at a later time by one of the available providers.

Another possible scenario is when a provider name is specified in the configuration file (so there is no need to make guesses as to what it might be), but for which the provider has not been installed. For example, an Oracle connection string may be present in a configuration file but Oracle may not be installed on the computer being used. Again, such a connection string is still added to the list of settings or marked in some way for presentation for possible validation. Later in the analysis process when validation occurs (which includes opening the connection), the fact that the provider is not installed may be brought to the user's attention in the validation results.

In some embodiments, when a configuration setting is identified as a connection string it may also be associated with a number of possible validations. These may be carried out at a later time, for example, once the configuration data has been parsed. Example possible validations are as follows:
Checking that the database connection can actually be opened. In order for this to happen, the username/password will need to be correct, and the database server accessible, amongst other things.
Checking that the computer associated with any hostname or IP address in the connection string belongs to the same Active Directory domain as the computer running the method of analysis.
Checking that the computer associated with any hostname or IP address in the connection string is not the computer running the analysis method. This check may not be present in some embodiments, because it may result in too many false positives. For example, in some cases it is perfectly legitimate for an application to be using a local database.

For the latter two validations explained above, the IP address or hostname is extracted from the connection string before the check can be carried out. There are a number of different ways in which this can be specified, so some embodiments of the disclosure may use the following algorithm:
Database connection strings consist of a number of key/value pairs, separated by semi-colons, e.g. “server=mattspc;UID=yourdatabaseusername;PWD=yourdatabaseuserpassword;databa se=yourdatabasename”;
The IP address or host name can be supplied using any of the following keys, depending upon the provider: “data source”, “host”, “server”, “network address”, “addr”, “address”, “remote server”, “srvr”;
Iterate through these possible keys to identify whether the key exists in the connection string. If so, the associated value is extracted. In the example database connection string above, the key would be “server” and the value would be “mattspc”. Once an instance of a key has been found, no further iteration is required.

For Microsoft SQL Server connection strings, account may be taken of the possibility that “(local)” or “.” could be used as an alternative to the more common “localhost” when referring to the local machine. Furthermore, there is the possibility of a named instance, e.g. “MattsPc\MySQLServer”. In this case the IP address/hostname is the part before the backslash (\).

2. Email Addresses

Embodiments of the disclosure may use conventional techniques for validating whether a setting is or contains a valid email address.

3. Directory/LDAP Query

To identify settings containing directory/LDAP queries, embodiments of the disclosure analyse whether a setting is prefixed with any of the following:
The name of the current directory domain (e.g. Active Directory Domain);
“WinNT://”; or
“LDAP://”.

If so, the configuration setting is determined to be of this type.

4. Website URL/Web Service URL

In this description it will be understood that exemplary methods of identifying a website URL are also applicable to the identification of a web service URL. Any mention of “website” should also be taken to include “web service” within its meaning.

In some embodiments of the disclosure, the criterion that is applied to determine a website configuration setting is whether, using the Microsoft-supplied URI class, an absolute URI for the HTTP or HTTPS scheme can be successfully created using the value supplied in the setting. If so, a website setting has been identified. For example, the setting “http://www.trademe.co.nz” would meet this criterion because this setting has the correct scheme (http://) and the rest of the URL (www.trademe.co.nz) obeys conventional rules for URL syntax.

If this particular test passes, and the associated setting is successfully determined to be a website, it may also, in some embodiments, be associated with a number of possible validations that may be carried out at a later time, for example, once the configuration data has been parsed. Example possible validations are as follows:
Checking whether the IP address or host can be successfully pinged. This may comprise sending a packet of data using the standard operating system PING utility, and seeing whether the remote computer replies. If it does not, then the remote computer may be switched off, or the IP address/host may be incorrect or refer to a computer that does not exist.
Checking that the computer associated with the hostname or IP address in the URL belongs to the same directory domain as the computer on which the analysis method is running.
Checking that the computer associated with any hostname or IP address in the connection string is not the computer running the analysis method. This check may not be present in some embodiments, because it may result in too many false positives. For example, in some cases it is perfectly legitimate for an application to be using a local database.
Requesting the content contained at the given URL. This is equivalent to typing the URL into the address bar in a web browser and making sure that the page actually returns some content—as opposed to a “404 not found” error, for example.

5. IP Address or Hostname

The criterion that is used to identify a configuration setting as an IP address or hostname in some embodiments of the disclosure is whether the setting is recognisable as an IP address (e.g. 192.168.0.1) or a hostname that DNS (the Domain Name System) knows about.

In order to determine this, it may be necessary to perform a DNS lookup. However, this may be an expensive operation in terms of time efficiency involving network access, so the method of some embodiments may comprise a number of performance optimisations.

Firstly for example, anything that is illegal in terms of IP address syntax may be ignored by using, for example, the Microsoft-supplied URI.CheckHostName method to ensure that the value provided meets the requirements for a valid Internet host name/IP address. It does not, however, perform a host-name lookup at this point to verify the existence of the host. This allows for the identification and discarding of settings which cannot possibly be valid IP addresses or hostnames, avoiding a lookup, thus saving time. For example, the setting “290.0.0.0” cannot be valid because IPv4 addresses consist of bytes in the range 0-255, which the value 290 clearly violates.

A second performance optimisation example relates to the desire to eliminate DNS lookups for settings which are technically legal but unlikely to be intended for use as IP addresses. An example of this is the value “1”. Technically, this is a valid IP address because it is shorthand syntax for 0.0.0.1. However, it is unlikely that any software developer would specify an IP address in this way. Therefore some embodiments of the disclosure may use the rule that, if the setting consists entirely of bytes separated by periods (.) then there has to be four bytes in total and otherwise it can be disregarded. Other embodiments may use different variations around such a rule, for example requiring that there are three or more bytes separated by periods. For example, IPv6 addresses have a different format to IPv4 addresses and consist of eight groups of 16-bit values, each represented as four hexadecimal digits and separated by colons, e.g. 2001:0db8:0000:0000:0000:ff00:0042:8329.

If the setting has passed a preliminary validation for IP addresses/hostnames such as explained above, a DNS lookup may then be provided. This step may use the lookup functionality provided by the Windows operating system. This may be performed in an asynchronous fashion, which allows the application to continue with other processing whilst waiting for the result of the lookup. This may be advantageous for throughput, performance and responsiveness in the user interface.

A limit may be placed on the time in which the DNS lookup is able to return a result. For example, in one embodiment of the disclosure, if the DNS lookup has not returned a result in 600 milliseconds, it is cancelled. It is noted that a typical operating system default timeout for DNS lookups is 15 seconds, but such a time frame would significantly impact the performance of the present disclosure.

If the DNS lookup succeeds, then this confirms that the setting is an IP address/hostname, and the associated setting is marked or added for future presentation to a user for possible selection. As with previously described configuration setting types, a number of possible validations that may be able to be carried out at a later time may be associated with the configuration setting. For an IP address/hostname, these possible validations may be the same as has been described above in relation to other setting types.

It is possible that the DNS lookup may not return anything, even if the identified IP address is valid. This might occur if the IP address belongs to a computer that is currently turned off or otherwise unavailable—DNS will not know about it. Therefore, if the DNS lookup is unsuccessful, another method may be used, for example the Microsoft-supplied IPAddress.TryParse method. If this indicates that the setting is legal according to IP address syntax, it is added to the list of identified settings. In some embodiments of the disclosure, the method may simply use the IPAddress.TryParse method, or similar, without the DNS lookup since anything that satisfies the former method is considered a confirmed configuration setting.

6. File or Folder

To identify a configuration setting as a file, a method according to embodiments of the disclosure examines the setting to determine whether it has an extension, i.e. is suffixed with several characters after a period (.). For example, “myfile.txt” has an extension, “myfile” does not. If an extension is present, the method performs the step of determining whether the extension is registered with the Windows operating system using any appropriate reference of registered Windows extensions. For example, the .docx and .doc extensions are associated with Microsoft Word. Another criterion that may be required to identify a file is that the initial portion of the filename i.e. the “myfile” in “myfile.txt” is not blank.

Assuming that the above conditions are true, the next step in an exemplary method according to the disclosure may be to ensure that the setting does not contain any characters that would be illegal in a filename, e.g. any of the following: \ / : * ? < > |. If this validation also succeeds, it may be assumed that the configuration setting is a file and it is marked or added to a list as a confirmed setting.

If the setting does not have a recognised extension, then it may be a folder. In order to determine this, some embodiments of the disclosure use the Microsoft-supplied Path.IsPathRooted method (http://msdn.microsoft.com/en-us/library/system.io.path.ispathrooted.aspx). This identifies whether the setting is prefixed with any recognisable root characters, such as “\”, “:” or “/”. For example the following settings would all be considered to be rooted—“c:\myfile.txt”, “\myfolder\”, “\\mypc\shareddocuments\”.

Assuming that the above is true, it is then assessed whether the setting contains any characters that would be illegal in a folder name. If this final validation succeeds, it may be concluded that, to a high degree of probability, the configuration setting is a folder, and it may be confirmed as a setting.

It is also possible that the setting is not rooted, but still a folder. For example, the setting “myfolder\mysubfolder\” is a folder, but is not prefixed with any root characters. Therefore some embodiments may include a step of checking to see whether the setting contains any path separator characters (\ or /). If so, and the setting does not contain any characters that would be illegal in a folder name, then again it may be concluded that, to a high degree of probability, the configuration setting is a folder, and it may be confirmed as a setting.

For each of the three scenarios identified above, settings which are too long to be a legal file or folder name for the relevant operating system (e.g. Windows) may also be disregarded.

Further considerations regarding identifying files or folders as a type of configuration setting in the parsing of configuration data are:
In the case of web applications (for example, where the configuration file is named web.config), the root character “I” in a file/folder setting often refers to the web application root and not the root of the current hard disk volume. For example, in Microsoft Windows, web applications are typically installed into a subfolder in “C:\inetpub\wwwroot” or similar. Thus, a web application in the location “C:\inetpub\wwwroot\mywebapplication” with a configuration file sitting in the same folder containing the setting “/myfolder” would be expected to be found in the following location “C:\inetpub\wwwroot\mywebapplication\myfolder” and not “C:\myfolder”. Web application paths may also be rooted using the tilde (˜) character.
If a file/folder is not rooted, it may be assumed that the path is relative to the folder containing the configuration file. For example, if analyzing a configuration file from “C:\program files\myapplication” which contains a file/folder setting of “mysubfolder\”, when performing a check it would be expected to be found in the following location: “C:\program files\myapplication\mysubfolder”.

In some embodiments of the disclosure, date values may be able to be recognised in a configuration setting. In some instances in conventional systems, a config value like “2/12/2014” would be identified as a folder, when it is almost certainly designed to be used as a date instead. To solve this problem, if the value contains two forward slashes (/), and is a legal date (according to the Microsoft DateTime.TryParse function), it may be identified as a date rather than a file or folder.

When a file or folder has been identified it may be associated with a number of possible validations that can be carried out at a later time. Example validations are as follows:
Does the file or folder actually exist on disk?
Is there permission to write to the file/folder?

7. Blank Config Settings

Blank configuration settings are identified if the key or value is missing or contains only spaces.

8. Unknown Settings

An unknown setting may be determined in some embodiments of the disclosure by determining whether the setting contains a Boolean value (e.g. 1 or 0, true or false) or a long integer value. In some embodiments of the disclosure, existing parse methods may be used to determine this. For example, the Microsoft-supplied TryParse method may be used. If the setting passes this method, there is a high probability that the configuration setting is not a connection string, URL, email address, IP address or file/folder therefore, for the purposes of the disclosure, it may be considered as an unknown setting type.

Optimisation

Different embodiments of the disclosure may perform the steps described above in different orders. Depending on the order in which steps are performed, some later steps may not need to be performed if positive confirmation of a particular validation step is made. Therefore, steps may be performed in an order to increase the likely speed of obtaining validation based on the relative abundance of certain configuration setting types. In some embodiments, further or all steps may be performed to increase the level of confidence in a check of validation step, perhaps in situations where speed is less critical or where a value can be associated with more than one configuration setting type. For example “trademe.com” could be an IP address/hostname or a file. As a result, some embodiments include logic steps to determine which of the possible configuration setting types is most likely. However, in general, if positive confirmation that a setting is of a particular setting type is achieved, it may be inefficient to perform further validation of that setting.

In one embodiment of the disclosure, the configuration setting determination methods discussed above may be performed in the following order to reduce the amount of unnecessary processing:
1. Is the setting a blank config setting?
2. Does the setting contain a Boolean value or a long integer value?
3. Is the setting an email address?
4. Is the setting a directory/LDAP query?
5. Is the setting a website or web service URL?
6. Is the setting an IP address or hostname?
7. Is the setting a database connection string?
8. Is the setting a file or folder?

If none of these methods results in the positive identification of a configuration setting type, then the method may conclude that the configuration setting is of an unknown type.

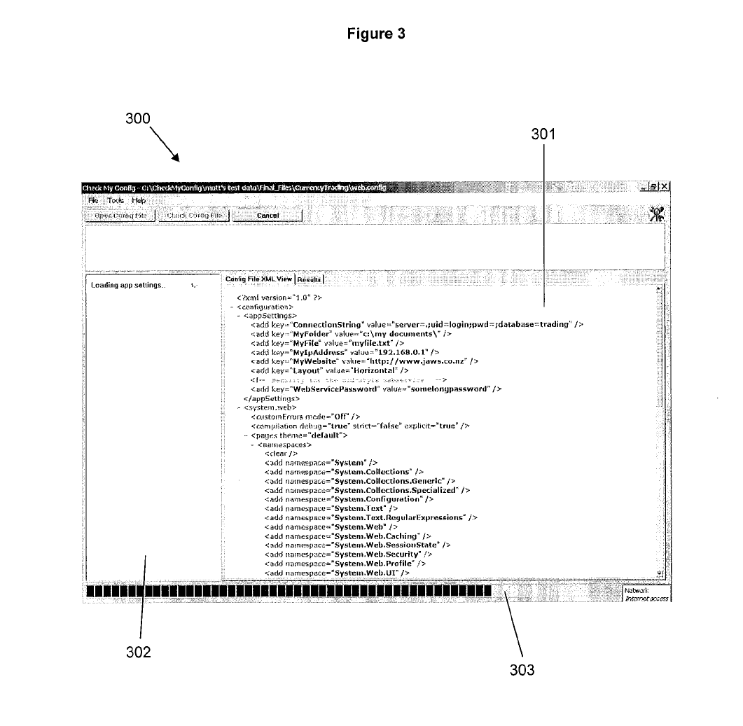

FIG. 3 is a screenshot of an exemplary GUI 300 illustrating a configuration file being parsed. Window 301 on the right hand side displays the raw structure of the configuration file. GUI 300 may also contain a status indicator 302 and a progress bar 303 providing feedback to the user while the parsing process is performed.

A parsing engine or other suitable means may be used to perform the parsing operation. Those of skill in the art will appreciate that the disclosure is not limited by the system or structure performing the disclosure.

Presenting Setting Type Determination Results

In some embodiments of the disclosure, the results of step 104, i.e. the determination of the types of the identified settings, are presented to the user at step 105. This may be done for information purposes or to allow the user to select the configuration settings, or the types of configuration setting, for which validation is to occur.

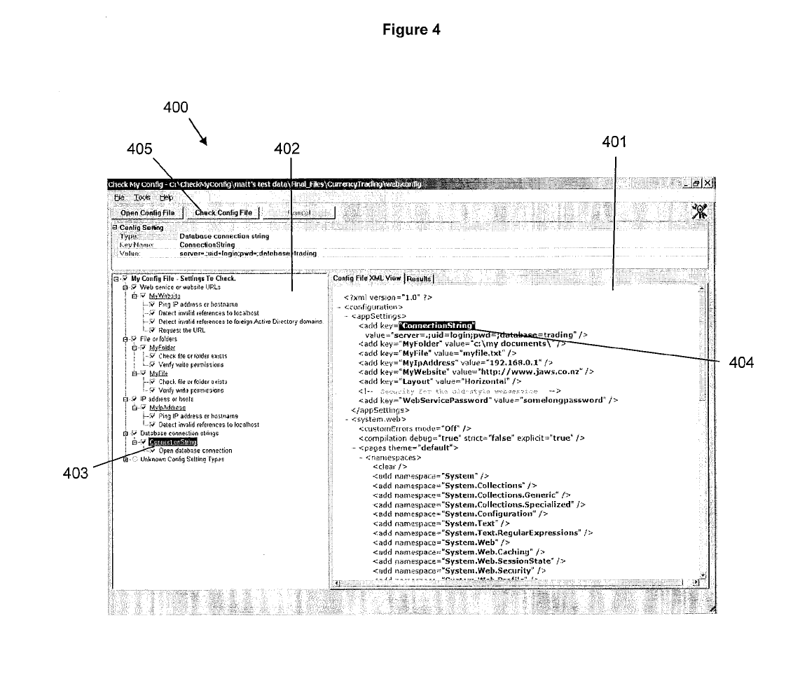

FIG. 4 is a screenshot of an exemplary GUI 400 illustrating the results of the setting type determination. Window 401 on the right hand side again displays the raw structure of the configuration file. Window 402 on the left hand side displays a hierarchy of the configuration setting types identified in the configuration data.

The hierarchy in window 402 in the embodiment of the disclosure shown in FIG. 4 contains the following information:
1. The root node corresponding to the configuration file that was selected by the user (e.g. “My Config File—Settings To Check”).
2. Below the root node are the different setting types (e.g. “Web service or website URLs”). Not all possible setting types will necessarily be present for any given configuration file.
3. Below the setting type nodes are the settings of that type identified in the configuration file (e.g. “MyWebsite”). There may be multiple settings for any given setting type.
4. Below the setting nodes is displayed a list of validations that may be carried out for the setting in question (e.g. “Ping IP address or hostname”). Examples of possible validations are described in relation to some of the configuration setting types above.

In window 402, each item has a tick box next to it allowing a user to select that item, or that group of items. For example, a user can select individual identified configuration settings or setting types. Other means for selection other than tick boxes may also be used.

In some embodiments, selecting a configuration setting or setting type in window 402 will cause the respective configuration setting(s) to be indicated in the raw configuration data of window 401. For example, in the example of FIG. 4, the configuration setting type 403, which is “database connection strings” has been selected and therefore any settings of this type are highlighted in window 401, such as setting 404. This enables a user to quickly and easily relate the configuration settings that have been identified in the parsing process to the raw configuration data.

GUI 400 may also comprise a window able to display further information on whatever item is currently selected within the hierarchy window 402.

At step 106, the user selects the configuration setting types, the configuration settings or the specific validations that are required. In the example shown in FIG. 4, selecting a configuration setting will automatically select all validations associated with that setting and selecting a configuration setting type will automatically select all the settings conforming to that type and also all the validations associated with those configuration settings.

GUI 400 comprises a “check config file” button 405 which is selectable by the user in order to begin the validation of the selected validations/configuration settings/types. As a result, the user's selection is received by the processor performing the validation.

In other embodiments, the method may omit steps 105 and 106 that enable a user to select which settings are validated, and simply validate all configuration settings that have been identified. However, the ability for a user to decide which settings are validated and which are not provides greater flexibility and may reduce unnecessary processing.

Validating the Configuration Settings

At step 107, the configuration settings corresponding to the user's selection are validated. This step may begin, in some embodiments, with a check that at least one setting has been selected and a determination of the number of validations that have been selected, either directly or by virtue of selection of the configuration settings with which the validations are associated. This enables feedback to be provided to a user on the overall progress of the operation.

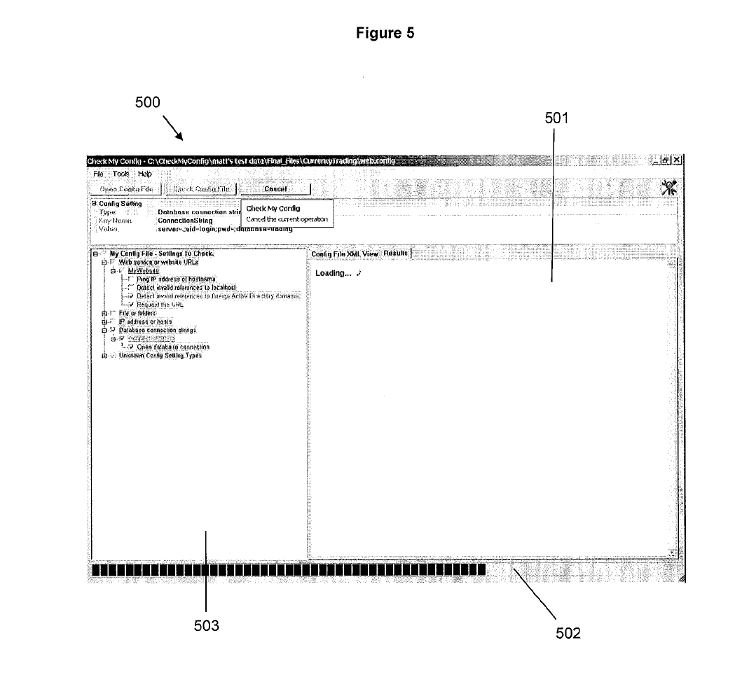

FIG. 5 is a screenshot of an exemplary GUI 500 illustrating the validation process in progress according to one embodiment of the disclosure. GUI 500 includes a results tab in window 501 which opens up and displays a status indicator. The GUI also comprises a progress bar 502 to show how far through the validation process has been reached. There may also be provided an ongoing indication of the results of the validation. For example, window 503 shows the configuration setting hierarchy as described in relation to FIG. 4 and items in this hierarchy turn green or red depending on whether the validation has passed or failed.

There will now be described exemplary methods of performing some of the validations discussed above. The methods are described by way of example only and it will be understood that other methods of performing the same validations may also be used. Other validations are also possible.

1. Database Connection Configuration Validation

If any database connection string settings were identified in step 104, each setting was associated with a list of data providers for which the connection string syntax is valid. A valid syntax does not necessarily mean that the connection can be opened. For example, a username or password in the connection string could be incorrect, or the database server could be unreachable. Some connection strings may be able to be parsed by more than one provider, but still result in an exception being thrown when the connection is opened.

The exemplary method attempts to open a database connection using each candidate data provider in turn. If a database connection is able to be opened successfully, the validation is deemed to have passed, and any errors caused by providers that did not work can be ignored.

If a database connection cannot be opened by any of the available providers, then the validation is deemed to have failed.

In order to increase performance the database connection timeout may be set at a predetermined level, e.g. 10 seconds, to allow the method to move on to the next validation if a connection cannot be made within a reasonable timeframe.

2. File/Folder can Write Configuration Validation

If the configuration setting associated with this validation relates to a file, this validation may comprise, for example, attempting to set the “LastAccessTime” attribute on the file itself using the Microsoft-supplied File.SetLastAccessTime method. If the file does not exist, or the current user does not have adequate permissions, or the file is locked by another process, this will cause an exception (error) to occur, which means that the validation has failed.

If the setting associated with this validation relates to a folder, this validation may comprise attempting to create a temporary file in the folder in question. If the folder does not exist, or the current user does not have adequate permissions, or the folder is locked by another process, this will cause an exception (error) to occur, which means that the validation has failed. If the file can be created, it is subsequently deleted and the validation has passed.

3. File/Folder Exists Configuration Validation

Depending on whether the setting associated with this validation is a file or folder, embodiments of the disclosure may use either the Microsoft-supplied IO.File.Exists or IO.Directory.Exists methods to determine whether the validation passes or fails.

4. Invalid Directory Domain Configuration Validation

In one embodiment of the disclosure, this validation involves examining the hostname or IP address associated with the parent setting and trying to determine whether it belongs to a computer that is in the same directory domain (e.g. Active Directory Domain) as the computer on which the analysis method is running. If it is determined to be in the same domain, the validation is deemed to have succeeded.

An Active Directory Domain consists of a number of different computers that are grouped together for administrative purposes and share resources such as printers, database servers, web servers, etc. Many organisations have different domains for development, test and production purposes. Software developers typically work in an isolated development domain which may limit their ability to accidentally interfere with production applications and data. However in many organisations it may still be possible to connect from one domain to another.

If an application connects from one domain to another, this may be unintended, for example being due to a mistake by a developer, i.e. a configuration problem. A common issue is connecting to a development or test domain from a production domain, or vice versa.

In some embodiments of the disclosure, the analysis method comprises obtaining a list of computers in the current domain. This step may involve, for example, querying the Microsoft-supplied WMI (Windows Management Instrumentation) classes. This list consists of computer host names as opposed to IP addresses. However, this is a time-consuming operation so, in some embodiments, it may only be performed once, for example during start-up of a software application that performs the analysis method, to avoid performance problems.

When this validation is performed, the list of computers in the current domain is used to see whether the IP address/hostname in the parent configuration setting belongs to a computer on this list. If an IP address is known, it may need to be converted into the associated hostname to perform this step. For example, an IP address such as 10.1.1.2 could be used to find the associated hostname (e.g. “MattsPC”) via a reverse DNS lookup. This is functionality provided by the Windows operating system. Other methods may also be used that are appropriate to the operating system being used.

There may be some factors that complicate obtaining hostname from an IP address, for example:
1. The hostname might belong to a computer that is on the public internet, as opposed to sitting on the same internal corporate network. In this case, the validation may be irrelevant. In order to detect this, the hostname may be examined to see whether it contains any characters that would be illegal in a netbios hostname (i.e. a hostname for a computer on an internal network). If the hostname contains a period (.), it is not local, e.g. “trademe.co.nz” is a fully qualified domain name on the public internet. Conversely, “MATTSPC” is a legitimate hostname on an internal network.
2. Some IP addresses may not be able to be resolved to a hostname, for example if the host is offline or otherwise unreachable. If a hostname cannot be determined, it cannot be compared to the list of hostnames in the current domain, hence the validation cannot be performed.

5. Invalid Local Host Validation

For this validation, the method attempts to determine whether the IP address/hostname associated with the parent configuration setting belongs to the local host (the same machine on which the analysis method is running). This validation may not be used in some embodiments because it may result in some false positives. For example, sometimes it is legitimate for a production application to connect to localhost.

In order to perform this validation, two lists are obtained:
1. All IP addreses and hostnames that belong to the local machine; and
2. All the IP addresses and hostnames that belong to the computer associated with the IP address/hostname in the setting.

It should be noted that a single computer can have multiple IP addresses/hostnames. For example, a computer may have the following hostnames/IP addresses: localhost/127.0.0.1, MATTSPC/10.1.1.4, as well as two hexadecimal IPv6 addresses.

If any entry from list 2 exists in list 1, it can be concluded that the local host is being dealt with, and the validation is deemed to fail.

6. Pingable IP or Host Configuration Validation

In some embodiments of the disclosure, the standard PING function of the operating system in use may be leveraged to send a packet of data to the IP address/hostname associated with the parent setting, and see whether a reply is received. If not, the validation is deemed to have failed. A possible cause is that the host is unreachable or offline or is not able to be pinged for security reasons.

7. Web Request Configuration Validation

This validation step may, in some embodiments, use existing methodology supplied with operating systems. For example, the Microsoft-supplied WebRequest.Create method can be used with the URL (e.g. “http://www.trademe.co.nz”) associated with the parent setting to create an HTTP request for the URL in question.

If there is no response within an allotted time, or an error occurs, then the validation is deemed to have failed. If a response is received, it may be necessary to examine the HTTP Status Code to determine whether the request succeeded or not. For example, the situation where the remote web server is alive, but the page we requested was not found may arise.

The following rules for success or failure for this validation are given with reference to the status code definitions provided at http://www.w3.org/Protocols/rfc2616/rfc2616-sec10.html:
If the Status Code starts with “1”, “2”, or “3”, the validation is deemed to have succeeded as the web request returned some valid content (HTML or XML, most likely).
If the Status Code starts with “4” or “5”, this indicates an error on the client or server. The validation is deemed to have failed.
Any other Status Code means that the result of the validation is deemed to be inconclusive.

Some embodiments of the disclosure include rules to convert the Status Code to a message which explains what the outcome of the validation means for later display to the user, regardless of success or failure.

Presenting the Validation Results

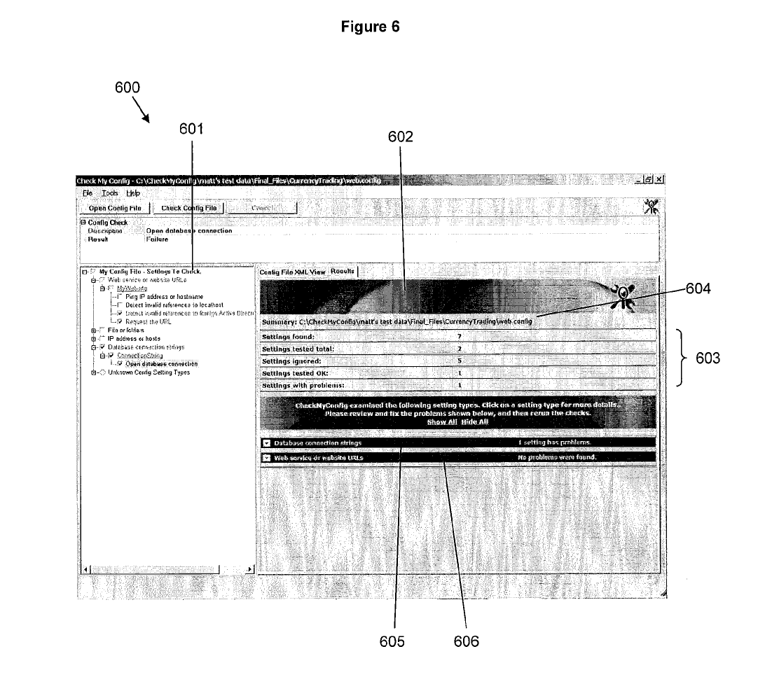

At step 108, the results of the validation process are presented on a user interface. FIG. 6 is a screenshot of an exemplary GUI 600 presenting the results of validation of configuration data according to one embodiment of the disclosure. GUI 600 may comprise a window 601 which illustrates an overview of the contents of the configuration data and the settings selected for validation, for example a hierarchy similar to window 503 shown in FIG. 5. GUI 600 also comprises a window 602 in which the results of the validation are presented.

In the embodiment shown in FIG. 6, window 602 may comprise an area 603 displaying an overall summary of the results, including for example: the number of settings identified in the configuration data; the number of settings selected for validation; the number of settings ignored in the validation process; the number of settings that passed validation; and the number of settings that failed validation. Window 602 also displays the name and location of the configuration file 604 that was analysed. Window 602 may also comprise one or more selectable elements 605 and 606 that may be selected to provide the user with more information on configuration data analysis results. The number of selectable elements may correlate to the number of configuration setting types that were identified in the configuration data. For example, in the embodiment shown in FIG. 6, only two setting types were selected for validation (database connection strings and web service or website URLs) so two selectable elements 605 and 606 are presented.

In one embodiment of the disclosure, any configuration settings not able to be validated (e.g. email addresses) or that were not selected for validation may be excluded from the results presented to the user. The user may be presented with the option to change how the results are presented, for example to include configuration settings that have been identified but not selected for validation, to order the results by setting or setting type, etc.

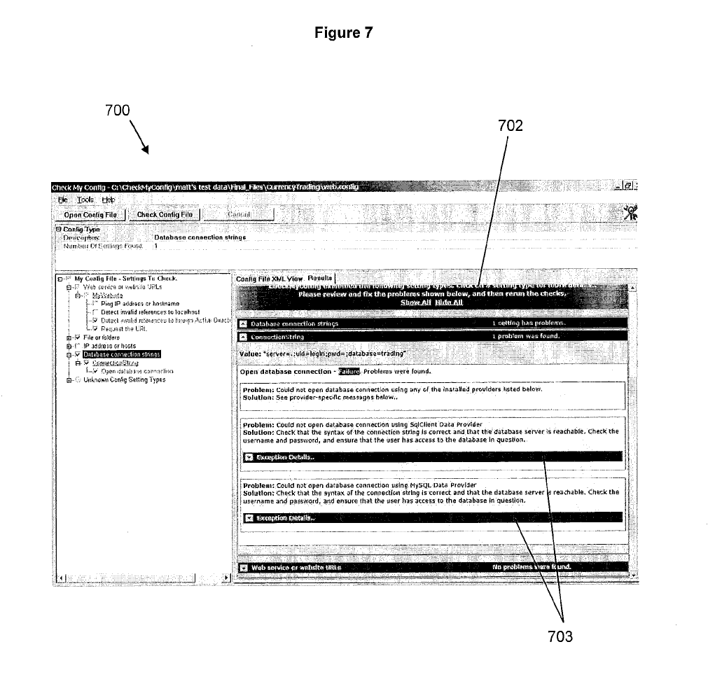

FIG. 7 is a screenshot of an exemplary GUI 700 presenting more detailed results of validation of configuration data according to the embodiment of the disclosure shown in FIG. 6. GUI 700 comprises a window 702 in which are displayed detailed information on the results of validation of settings that are database connection strings. This information identifies the setting that failed and explains why validation failed.

If a validation fails, the method may comprise the step of presenting information or feedback on the user interface relating to the validation result. For example, the information may comprise an explanation of what caused the validation to fail, any associated exception/error messages, and a recommended solution. This information is generated automatically based on the outcomes of the validation.

For example, in the embodiment shown in FIG. 7, the identified ConnectionString setting has failed validation because of two problems. The two problems are both identified and suggestions for resolving these problems are suggested. Such suggestions may be generated by a feedback algorithm which identifies the relevant feedback based on results of the steps of the validation process and relevant feedback or solution text which is selected depending on the characteristics of why the validation failed. Selectable buttons 703 may also be provided whereby display of the exception details can be selected by the user.

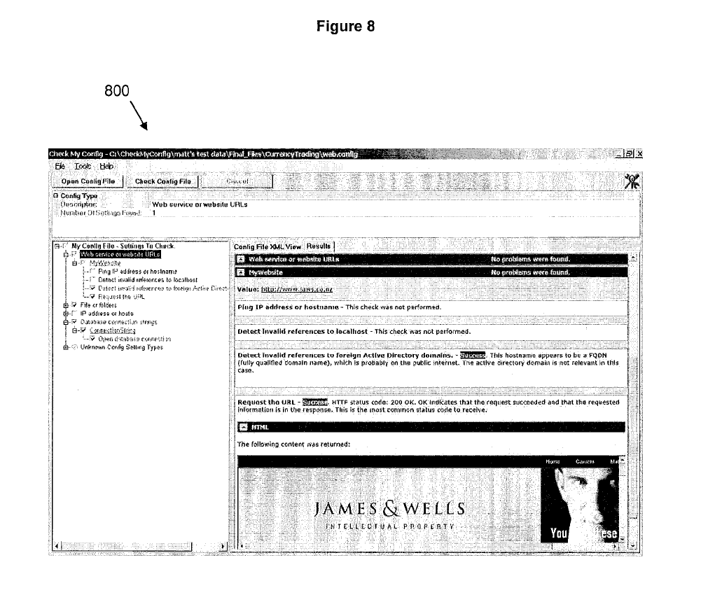

FIG. 8 is a screenshot of an exemplary GUI 800 presenting more detailed results of validation of configuration data according to the embodiment of the disclosure shown in FIG. 6. In FIG. 8, the results of validation of the web service or website URLs configuration settings are displayed to the user. These results show examples of what may be presented to a user if validations are not performed (as in the top two results) or validation is passed (as in the bottom two results). Information may be provided that explains why validations have passed. Such information is generated automatically, for example based on an algorithm that generates the feedback information based on the steps of the validation process and information obtained during the process.

Once the analysis is complete, a user has the opportunity to amend the configuration data to rectify any issues identified. This allows the user to fix whichever problems they decide to and, if the necessity arises, leave some problems unsolved. The user is also able to rectify each issue one by one and re-analyse the configuration data each time to ensure no knock-on issues have occurred as a result of any changes.

Application Programming Interface

In some embodiments of the disclosure, an Application Programming Interface (API) is provided such that the computer-implemented method is executed without the need for a user interface. In other embodiments both an API and a user interface may be provided.

In such an embodiment, any of the functionality available through the user interface may be made available programmatically via the API, including the selection of a config file, validation checks to ensure that the config file exists and can be read, parsing of the settings contained therein, and selection and execution of the various checks associated with the settings.

The skilled addressee will understand upon reading the above description of the ‘user interface’ version of the disclosure how an appropriate API may be implemented. In line with the ‘separation of concerns’ principle of software architecture, the user interface version may be implemented with an ‘internal API’ which comprises software configured to provide parsing and checking functionality. The user interface receives user input, passes and receives messages to and from the internal API, and displays information to the user. In such an embodiment of the disclosure the user interface does not execute any of the steps of parsing or checking of config settings. As such, an API can be written to automatically perform the steps that may be performed by the user interface.

In one embodiment of the disclosure, a user interface version of an application able to execute a computer-implemented method of an embodiment of the disclosure may be adapted to provide an API application according to the disclosure by making the following changes:
Exposing the config parsing/checking functionality to external applications, and hiding any irrelevant internal implementation details—i.e. encapsulation. For example, a user of the API needs to be able to programmatically select settings to be checked, but doesn't need to know the inner workings of any of the config setting checking algorithms. Similarly, a user of the API doesn't need to have access to any of the user-interface components such as forms, buttons, dialogs etc, so they are hidden.
Providing documentation to explain how to use the API—this may take the form of ‘intellisense’ comments which a software developer would see in their IDE (integrated development environment), and code samples which illustrate how to integrate a third-party application with an application able to execute the computer-implemented method of the disclosure.

The algorithm and steps involved in parsing and checking settings in an API version of the disclosure according to one embodiment may be exactly the same, bar one addition, as those in a user interface version of the disclosure according to another embodiment. An API may be configured to automatically detect the location of the config file associated with a third-party application so that it does not need to be supplied by the user of the API (although in one embodiment the user may be able to do so). The auto-detection functionality may be achieved in a number of ways, including through a built-in function in the Microsoft .NET framework.

Below is shown exemplary code in Visual Basic of a very simple example of API usage, which shows how to load a config file and check all of the settings, then examine the results. To achieve the same thing in the example of the user interface, the user may click the ‘Open Config File’ button, browse to the file c:\myapp.config, select it, wait for it to load, and then click ‘Check Config File’.

Dim checker As New ConfigFileChecker(″c:\myapp.config″)
checker.OpenConfigFile( )
checker.CheckConfigFile( )
For Each setting In checker.CurrentConfigFile.ConfigSettings

′Enumerate the config settings once checks have been

carried out..

For Each checkPerformed In setting.PossibleChecksToPerform

′For each setting, list the checks that were carried

out.

If checkPerformed.Result.Status =

ConfigCheckResult.ResultStatus.Failure Then

′Something went wrong with this check. Let's list

the problems..’

For Each problem In

checkPerformed.Result.Problems

′TODO - take appropriate action based upon

the problem.. you might want to log the
′problem, halt the application, raise an error, etc.

Next

End If

Next

Next

An API allows the disclosure to be incorporated into, or be interacted with via, another application. In one example, the computer-implemented method of an embodiment of the disclosure may execute during the running of this application, for example at start-up.

### Alternative Embodiments of the Disclosure

An exemplary method according to one embodiment of the disclosure has been described above in terms of analyzing configuration data that is stored in a configuration or config file. Such files are commonly stored in association with a computer program or software application and may, for example, be saved with a .config extension. However, the disclosure is not limited to configuration data stored in such a way. Other types of files or other locations for the storage of configuration data are also possible and included within the scope of the disclosure. For example, configuration data may be stored in a database in another embodiment of the disclosure.

In some embodiments of the disclosure, the analysis method according to the disclosure is performed by a program or application running on one or more computing devices or processors. The disclosure is not limited to the hardware, devices, systems or structure thereof used to implement the disclosure. For example, GUIs according to embodiments of the disclosure such as exemplified above may be displayed on any appropriate display device, including but not limited to a computer screen, tablet, smartphone or the like.

References in the above description are made to Microsoft tools and operating systems. Some embodiments of the disclosure may be provided as a .NET application that is able to analyse configuration settings for applications or programs able to run on the Microsoft .NET framework, e.g. web applications, Windows applications (WinForms or WPF), Windows services, console applications, or any other .NET application with an associated configuration file or associated configuration data. Such embodiments do not limit the disclosure and other embodiments may be provided to run with applications on other platforms, frameworks, operating systems or the like.

Some alternative embodiments of the disclosure may comprise method steps involving the generation of possible amendments to at least one of the configuration settings identified that fails validation. To achieve this there may be provided one or more algorithms that generate an amended form of a configuration setting that may resolve the fault, the amended form being generated based on information obtained during the validation step. In some embodiments, the one or more faulty configuration settings may be automatically amended. Alternatively, the method may suggest modifications to something a configuration setting refers to. For example, a file/folder configuration setting may refer to a folder that does not exist. The user may be provided with the option to create the folder automatically, or the folder may be created without seeking permission from the user, thus negating the need to change the configuration setting.

In some embodiments of the disclosure, one or more timeout settings for connection to a remote location may be able to be configured by a user. By selecting a shorter timeout setting, parsing and checking of config settings will be quicker but less reliable. A longer timeout setting will result in slower but more reliable parsing and checking. The optimal setting will partly depend on the speed of the users network connection. For example, the default timeout value for opening a database connection is 15 seconds—if the connection is not opened successfully in this period of time, the check is deemed to have failed. However a slow network connection (connecting to a remote database, for example) might lead to the desire to set a higher timeout value (20 seconds, say) to ensure that the check doesn't fail prematurely.

Default timeouts are as follows:
IP Address Or Host Config Setting: Timeout of 600 milliseconds to receive a response from DNS (this affects parsing rather than checking);
Database Connection Config Check: Timeout of 15000 milliseconds to open a database connection;
Pingable IP or Host Config Check: Timeout of 1200 milliseconds to receive a response to a PING request; and
Web Request Config Check: Timeout of 10000 to receive a response to a web request for a URL.

In one embodiment of the disclosure, any or more of these timeout values can be configured through an interface, for example by a user by altering a timeout setting via a user interface or automatically through an API. In the example of adjustment through a user interface, the timeout settings are presented to a user on a user interface, the new timeout setting(s) are selected by the user, and timeouts are then executed based on the new timeout setting(s).

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations. It will be appreciated that one example of a device capable of performing the method steps described above is a conventional computer, such as a PC or laptop computer, and it can do so when executing software embodying a method or algorithm according to the disclosure.

The steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor can read information from, and write information to, the storage medium. In the alternative, the storage medium may be integral to the processor. Disk and disc, as used herein, includes compact disc (CD), laser disc, optical disc, digital versatile disc (DVD), floppy disk and blu ray disc where disks usually reproduce data magnetically, while discs reproduce data optically with lasers. Combinations of the above should also be included within the scope of computer readable media. The processor and the storage medium may reside in an ASIC. The ASIC may reside in a user terminal. In the alternative, the processor and the storage medium may reside as discrete components in a user terminal.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

The disclosure may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the embodiments described herein will be apparent to those skilled in the art. Such changes and modifications may be made without departing from the spirit and scope of the disclosure and without diminishing its attendant advantages. It is therefore intended that such changes and modifications be included within the present disclosure.

1. A computer-implemented method of analyzing configuration data comprising one or more configuration settings, the method comprising:
identifying the one or more configuration settings in the configuration data;
determining a setting type of each of the one or more configuration settings; and
validating one or more of the identified configuration settings based on the setting type of the identified configuration settings.

2. A computer-implemented method as claimed in claim 1, wherein the method comprises:
presenting to an interface the identified configuration settings; and
receiving a selection of one or more of the identified configuration settings; and
validating the selected identified configuration settings.

3. A computer-implemented method as claimed in claim 2, wherein the method further comprises:
presenting to the interface the setting types of the identified configuration settings;
receiving a selection of one or more of the setting types for validating; and
validating the identified configuration settings that match the selection of setting types.

4. A computer-implemented method as claimed in claim 2, wherein the method further comprises associating one or more validations with the identified configuration settings.

5. A computer-implemented method as claimed in claim 4, wherein the method further comprises:
presenting to the interface the validations associated with the identified configuration settings;
receiving a selection of one or more of the validations; and
validating the identified configuration settings according to the selected validations.

6. A computer-implemented method as claimed in claim 2, wherein the method comprises presenting the results of the validating the identified configuration settings to the interface.

7. A computer-implemented method as claimed in claim 2, wherein the method comprises presenting the results of the validating on the interface with the configuration data.

8. A computer-implemented method as claimed in claim 2, wherein the method comprises presenting information relating to the results on the interface.

9. A computer-implemented method as claimed in claim 8, wherein the information comprises a statement or explanation as to why the validation passed or failed, and/or, in the case of a failed validation, a suggestion of what may help to pass the validation.

10. A computer-implemented method as claimed in claim 8, wherein the method comprises generating the information relating to the results based on the validating.

11. A computer-implemented method as claimed in claim 2, wherein the interface is a user interface.

12. A computer-implemented method as claimed in claim 2, wherein the interface is an Application Programming Interface (API).

13. A computer-implemented method as claimed in claim 1, wherein the determining the setting type of each configuration setting comprises implementing one or more algorithms, wherein each algorithm determines whether the respective configuration setting is of a particular configuration setting type.

14. A computer-implemented method as claimed in claim 1, wherein the method comprises ceasing the determining once a positive identification of a configuration setting type has been made.

15. A computer-implemented method as claimed in claim 1, wherein the method comprises determining whether each identified configuration setting is one or more of a configuration setting type selected from: a blank configuration setting, a configuration setting comprising a Boolean value or a long integer value, an email address, a directory/LDAP query, a website or web service URL, an IP address or hostname, a database connection string, or a file or folder.

16. A computer-implemented method as claimed in claim 1, wherein the validating the identified configuration settings comprises validating one or more of: a database connection, ability to write to a file/folder, existence of a file or folder, validity of a directory domain, validity of a local host, connectivity to an IP address or hostname, and existence of a web page or website.

17. (canceled)

18. (canceled)

19. A computer-implemented method as claimed in claim 1, wherein one or more timeout settings for connection to a remote location are configured through an interface.

20. A computer-implemented method as claimed in claim 19, wherein the method comprises presenting timeout settings to a user on a user interface, receiving a new timeout setting(s) selected by the user and executing timeouts based on the new timeout setting(s).

21. (canceled)

22. A non-transitory computer-readable storage having stored thereon computer-executable instructions which, when executed on a computer, causes the computer to perform a method according to claim 1.

23. A system of analyzing configuration data comprising one or more configuration settings, the system comprising:
an identifier identifying one or more configuration settings in the configuration data;
a determiner determining a setting type of each configuration setting; and
a validator validating one or more of the identified configuration settings based on the setting type of the identified configuration settings.

24. (canceled)

25. (canceled)

26. (canceled)
